(19) United States
(12) Patent Application Publication
(10) Pub. No.: US 2016/0338407 A1
(43) Pub. Date: Nov. 24, 2016

(54) PROGRAMMABLE VAPORIZER DEVICE AND METHOD

(71) Applicant: Andrew Kerdemelidis, London (GB)

(72) Inventor: Andrew Kerdemelidis, London (GB)

(21) Appl. No.: 14/715,567

(22) Filed: May 18, 2015

(51) Int. Cl. A24F 47/00; H05B 1/02

(52) U.S. Cl. CPC A24F 47/008; H05B 1/0244

(57) ABSTRACT

The invention relates to a programmable vaporizer device and method that allows a user to controllably atomize a plurality of aerosol-forming substrates having different flavors in order to generate an aerosol mixture with a specific flavor profile and share that flavor profile with other users over a computer network. Preferably, the vaporizer device includes a user interface adapted to create a flavor profile by allowing a user to determine the intensity of specific flavors over the duration of inhalation.

### FIELD OF THE INVENTION

The present invention relates generally to a programmable vaporizer device and method.

Particularly, but not exclusively, the invention relates to a programmable vaporizer device and method that allows a user to controllably atomize a plurality of aerosol-forming substrates having different flavors in order to generate an aerosol mixture with a specific flavor profile and share that flavor profile with other users over a computer network. Preferably, the system includes a user interface adapted to create a flavor profile by allowing a user to determine the intensity of specific flavors over the duration of inhalation.

### BACKGROUND OF THE INVENTION

Modern vaporizer devices present an alternative to smoking tobacco and work by atomizing a fluid called ‘e-liquid’, which is comprised typically of a mixture of propylene glycol, glycerin, nicotine and a flavoring agent. The e-liquid is usually atomized by a small heated coil wrapped around a wick that is saturated in e-liquid. A current is passed through the coil, heating it to the point where the fluid on the wick and in proximity to the coil is atomized because a boiling point is reached for the e-liquid. This atomized e-liquid forms the visible ‘aerosol’ of an e-cigarette, and a user who is inhaling and exhaling the aerosol is considered to be ‘vaping’.

Flavors are normally added to the e-liquid prior to being sold and the fluid being loaded into the vaporizer device or “e-cigarette”, and users can select from a range of pre-mixed flavors to make the vaping experience more enjoyable. It is also possible to vaporize solid substrates, including plant material such as tobacco or other herbs, by increasing the heat applied to the substrate until active ingredients reach boiling point but the plant material is not combusted. This minimizes the amount of toxic chemicals inhaled by a user compared to when the plant material is combusted when smoking a cigarette or pipe.

The main disadvantage with the prior art is that a user is typically limited to experiencing only one flavor at the same time and has to mix their own substrate manually in order to alter the flavor experience. A user's experience is also limited to the substrates that are commercially available and there is limited control over how the substrates are atomized. A user also has limited means to dynamically control the flavors experienced and share this experience of new flavors with others.

Fernando et al. in U.S. Pat. No. 8,402,976 discloses an electrically heated smoking system for receiving an aerosol forming substrate, which includes an interface for establishing a communications link with a host. However, there is no disclosure of a means for allowing dynamic control over atomization and allowing multiple flavors to be experienced during inhalation.

Lui in US Pat. App. No. 20140060556 discloses a multi-flavored cigarette. An electronic cigarette having at least two atomizing chambers is disclosed, allowing a user to choose single, multiple, or any combination of flavors. However, there is no disclosure of a means to dynamically control the flavors experienced and share this experience of new flavors with others over a communications link.

There is a need for a programmable vaporizer device method to overcome these deficiencies in the prior art. The present invention overcomes these and other disadvantages.

### SUMMARY OF THE INVENTION

It is an object of the present invention to provide an apparatus and method for allowing a user to experience and share an aerosol mixture having a specific flavor profile.

It is a further object of the present invention to provide an apparatus and method which allows a user to controllably adjust and generate a multi-flavored experience when vaping.

It is a further object of the present invention to allow a user to controllably select the duration and intensity of atomization of various substrates that are to be inhaled and share this with other users.

Further objects and advantages of the present invention will be disclosed and become apparent from the following description. Each object is to be read disjunctively with the object of at least providing the public with a useful choice.

In a first aspect the invention provides a programmable vaporizer device comprising:

a plurality of aerosol-forming substrates having different flavors;

means for atomizing said substrates connected to at least one chamber;

a power supply configured to power said means for atomizing said substrates;

at least one air inlet and outlet in communication with said chamber;

a programmable controller directly or wirelessly connected to said means for atomizing said substrates and configured to atomize said substrates using a pre-determined intensity and duration of atomization over time to generate an aerosol mixture in accordance with at least one flavor profile;

means for activating said programmable controller to generate said aerosol mixture within said chamber which can be inhaled by a user from the outlet.

Preferably, said programmable controller includes a user interface allowing a user to create a new flavor profile by modifying the intensity and duration of atomization of said substrates over time.

Preferably, said vaporizer device includes a communications link with a remote host operable to download a flavor profile to said programmable controller and upload flavor profiles or device usage information to the remote host to share with other users.

Alternatively, said vaporizer device includes a communications link with at least one other vaporizer device allowing the exchange of flavor profiles.

Preferably, said programmable controller includes means for detecting the duration and/or force of inhalation by said user.

Preferably, said programmable controller adjusts the flavor profile in a pre-determined manner in accordance with duration and/or force of inhalation by said user.

Preferably, user interface includes touch-enabled surface means or push-button means allowing a user to generate a flavor profile by specifically controlling the level of atomization of a certain flavor.

Preferably, said programmable controller adjusts the flavor profile in accordance with external parameters in pre-determined manner, said external parameters including specific environmental cues.

Preferably, said programmable controller includes a haptic interface configured to provide a user with haptic feedback in response to use of the vaporizer device.

Preferably, said aerosol-forming substrates include means for allowing identification of the individual composition of those substrates.

Preferably, said aerosol-forming substrates comprise liquid substrates, contained within a cartridge receivable in a housing. Preferably, said liquid comprises one or more of glycerine, propylene glycol and nicotine.

Alternatively, a solid substrate may be provided such as tobacco or dried herbal material.

Alternatively, said aerosol-forming substrates comprise compounds having a therapeutic or psychological effect.

Preferably, said means for atomizing said liquid substrates comprise means that do not use heat including an ultrasonic actuator and/or ultrasonic mesh.

Preferably, said ultrasonic mesh includes means for heating a liquid substrate to reduce its viscosity.

Alternatively, said means for atomizing said substrates comprise means that use heat including a heated coil, conduction atomizer, or convection atomizer.

In a second aspect the invention provides a method of generating a flavor profile on a programmable vaporizer device comprising the steps of:

providing a plurality of aerosol-forming substrates having different flavors;

providing means for atomizing said substrates connected to at least one chamber;

providing a power supply configured to power said means for atomizing said substrates;

providing at least one air inlet and outlet in communication with said chamber;

providing a programmable controller directly or wirelessly connected to said means for atomizing said substrates and configured to atomize said substrates using a pre-determined intensity and duration of atomization over time to generate an aerosol mixture in accordance with at least one flavor profile;

providing means for activating said programmable controller to generate said aerosol mixture within said chamber which can be inhaled by a user from the outlet.

More specific features for preferred embodiments are set out in the description below. To the accomplishment of the above and related objects the invention may be embodied in the form illustrated in the accompanying drawings. Attention is called to the fact, however, that the drawings are illustrative only. Variations are contemplated as being part of the invention, limited only by the scope of the claims.

### BRIEF DESCRIPTION OF THE DRAWINGS

The invention will now be described by way of example only with reference to the accompanying drawings, in which:

FIG. 1 is a schematic plan view of a heat-based atomizing module suitable for an embodiment of an vaporizer device having a serial construction in accordance with the invention.

FIG. 2 is a schematic plan view of a heat-based atomizing module suitable for an vaporizer device having a parallel construction in accordance with the invention.

FIG. 3 is a schematic plan view of a heat-based atomizing module with a directly driven element.

FIG. 4 is a schematic plan view showing airflow through an atomizing module in accordance with an embodiment of the invention.

FIG. 5 is a schematic plan view showing an vaporizer device incorporating heat-based atomizing modules in a serial construction in accordance with an embodiment of the invention.

FIG. 6 is a partial view of the schematic plan of FIG. 6.

FIG. 7 is a schematic plan view showing an embodiment of the invention with direct element control.

FIG. 8 is a schematic plan view showing the internal functional modules of a programmable controller in accordance with an embodiment of the invention.

FIG. 9 is a schematic plan view of the slave circuit controller in accordance with an embodiment of the invention.

FIG. 10 is a flow diagram of an exemplary process whereby a user may generate and share a flavor profile in accordance with an embodiment of the invention.

FIG. 11 is an illustration of an exemplary user interface showing how a user may browse, edit or create a flavor profile in accordance with an embodiment of the invention.

FIG. 12 is an illustration of an exemplary user interface showing how a user may adjust the intensity and duration of atomization of a plurality of flavored substrates to generate a new flavor profile in accordance with an embodiment of the invention.

FIG. 13 is a schematic representation of a network system allowing communication between programmable vaporizer devices and various services over the Internet in accordance with an embodiment of the invention.

FIG. 14 is a schematic representation of a peer-to-peer system allowing direct communication between Vape Devices in accordance with an embodiment of the invention.

FIG. 15 is a schematic plan view of an ultrasonic atomizer using an ultrasonic coupling device in accordance with an embodiment of the invention.

FIG. 16 is a schematic plan view of an alternative ultrasonic atomizer in accordance with an embodiment of the invention

FIG. 17 is a schematic plan view of a thermal inkjet-style atomizer in accordance with an embodiment of the invention.

FIG. 18 is a schematic plan of a microfluidic atomizer in accordance with an embodiment of this invention.

FIG. 19 is a schematic plan of an embodiment of an vaporizer device incorporating the heat-based atomizing modules of FIG. 2 in a parallel construction.

FIG. 20 is a schematic plan of an ultrasonic mesh atomizer in accordance with an embodiment of the invention.

FIG. 21 is a schematic plan of a vertical ultrasonic mesh atomizer in accordance with an alternative embodiment of the invention.

FIG. 22 is a schematic plan of an embodiment of a vaporizer device incorporating the non-heat-based ultrasonic mesh atomizer modules of FIG. 20 in a parallel construction.

FIG. 23 is a schematic top view of an ultrasonic mesh assembly in accordance with an embodiment of this invention.

FIG. 24 is a schematic side view of an ultrasonic mesh assembly in accordance with an embodiment of this invention.

FIG. 25 is a schematic plan view showing an alternative ultrasonic horn atomizer with mesh in accordance with an embodiment of the invention.

### DETAILED DESCRIPTION OF THE INVENTION

Various embodiments of the present invention are described hereinafter with reference to the figures. It should be noted that the figures are only intended to facilitate the description of specific embodiments of the invention. In addition, an aspect described in conjunction with a particular embodiment of the present invention is not necessarily limited to that embodiment and can be practiced in any other embodiments of the present invention.

The present invention relates to a system and method of using a vaporizer device including a programmable controller to atomize aerosol-forming flavored substrates such that multiple flavors can be dynamically generated for the user, under that users' control. In this specification the vaporizer device may also be referred to as a Vape Device. It should be recognized that the Vape Device allows substrates can be inhaled which are not nicotine or tobacco based, and the Vape Device may also used for the purpose of administering substrates having a therapeutic effect.

For the purposes of simplicity, the primary means of atomizing an aerosol-forming substrate referred to in this description will be the thermal electric coil method. In general, atomizers using heat operate by combustion, conduction or convection. However, those skilled in the art will recognize that system disclosed can utilize other methods for generating atomized particles of a small enough size that resemble aerosol, or to atomize the flavor components. For example, other mechanisms able to be used for generation of the aerosol include pneumatic and ultrasonic nebulization (which do not use heat), heating with a ceramic or sintered element, and heating the fluid with a laser that impinges a surface. These various atomization mechanisms will be discussed below as alternative embodiments of the invention. While there exist differences in terminology regarding the different methods to convert a substrate into an aerosol, including atomizers, vaporizers and nebulizers, in this specification the term “atomizer” will refer to them all. There are also advantages of atomizers that do not use heat as they are less likely to degrade heat sensitive ingredients. This can improve the flavor experience or allow the inhalation of substrates comprising soluble compounds with certain therapeutic effects or health benefits. For example, such atomizers can facilitate inhalation of a substrate such as a pharmaceutical, supplement, vitamin or nutriceutical. Alternatively, the substance can Another benefit of using atomizers that do not require heat is that a greater variety of water-soluble substrates can be used and it is not necessary to add propylene glycol or glycerin to facilitate atomization. It will also be apparent to those skilled in the art that it is possible to combine the different atomizer mechanisms in the same device, for example, using ultrasound combined with thermal electric coil or pneumatic atomization.

This specification will refer to the dynamically generated multiple flavors generated by the various methods of atomizing the aerosol-forming substrates as a ‘flavor profile’, which is a data structure that describes the proportion of intensity and evolution of a plurality of flavors throughout an inhalation (also referred to as a ‘drag’) the user takes from their Vape Device. Flavor profiles can be static, in which the proportion of each of the flavors throughout an inhalation do not vary but are set to a users' preference, or can be dynamic, where the intensity of each individual flavor varies across the duration of an inhalation.

The flavor profile can also be adjusted with reference to external parameters that adjust the flavors generated in the flavor profile. Such external parameters include but are not limited to environmental cues such as time of day, ambient lighting, drag strength of the user, number of puffs the user is taking, type of flavors loaded into the Vape Device, proximity to other users, GPS location, proximity to a wearable device, input from an accelerometer and/or gyroscope, air pressure sensor, temperature sensor control switches, microphone, camera, battery level and/or capacity sensor, touch sensor, resistivity sensor, humidity sensor, temperature sensor, rotary encoder or level switch. To control the flavor profile, the user can pair the Vape Device to a mobile phone wearable device including but not limited to wireless radio connections such as Bluetooth or WIFI infrared remote controller or through ultrasonic signaling, and utilize a user interface on that device to adjust the flavor profile to their preference. The user may also utilize an interface that is directly on the Vape Device itself, including but not limited to a touch-enabled area, rotary encoder or push-button. The Vape Device and/or the device that is used to control the Vape Device can store a plurality of flavor profiles, and these can be selected by the user at will.

The user may also share their flavor profile online on a service that connects users of the Vape Device in the manner of a social network, so that those users can also explore flavors created by that user. In this way, the vaping experience can be made more ‘social’ where people who enjoy vaping can engage in conversation and share their favorite flavors online. Shared flavors can be ‘liked’ or ‘favorited’ on this vaping-based social network, and a user can select a shared flavor profile for use on their own Vape Device. They can also ‘remix’ flavor profiles and re-share with users on the online service. Users can enter into ‘groups’ that have one or more flavor profile associated with them. A users' status on such a social network can be seen, including the flavors they have been recently vaping, when they are currently vaping, and an animated view of when they are currently inhaling from their Vape Device, which may include the strength of their inhalation through the device as well as the current flavor profile being used.

A user may also choose to chat with other currently vaping users, or comment, rate and/or ‘favorite’ or bookmark flavor profiles, upload images, including downloading these for use on their own Vape Device. A user can also send a flavor profile to another user, either through the online service, or directly from one Vape Device to another.

The method by which flavor of the aerosol can be controlled using a flavor profile is disclosed. The device contains a plurality of individually controllable atomizers, each which contains an aerosol-forming substrate such as an e-liquid and/or flavoring agent. The atomizer technology may be thermal, for example using a coil or other suitable heating element or method, including but not limited to nickel-chromium wire wrapped around a saturable wick, sintered absorbent conductive rod, resistive heater, or it can be ultrasonic or pneumatic, for example using compressed air jet across an air gap, or a piezo transducer to atomize the e-liquid directly without the use of heat, or a combination of these methods. Those skilled in the art will also recognize that there are many other mechanisms that can be used to generate controlled amounts of aerosol, as noted above. It may also be possible to generate aerosol or flavor vapor directly from a solid substance, not just a liquid. Therefore, it is apparent that a plurality of controllable atomizers may be used with the invention.

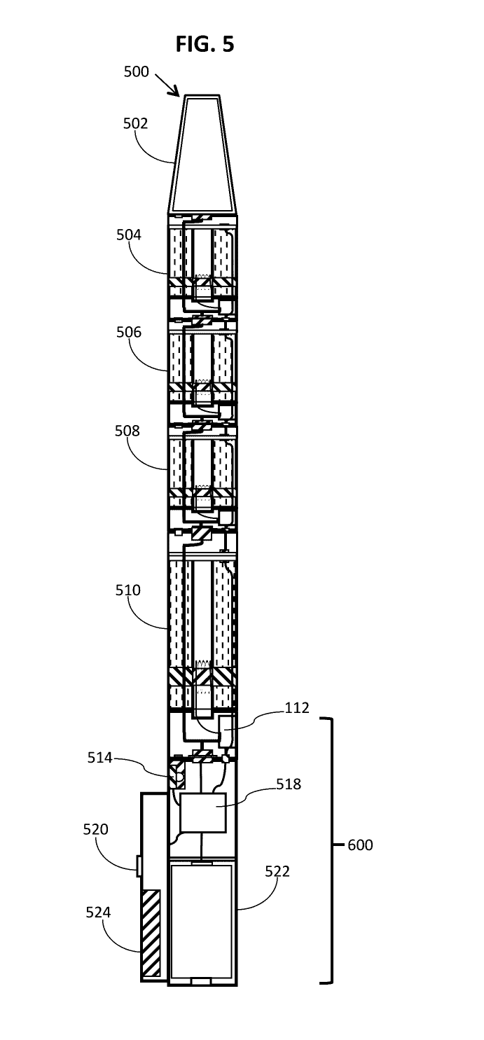

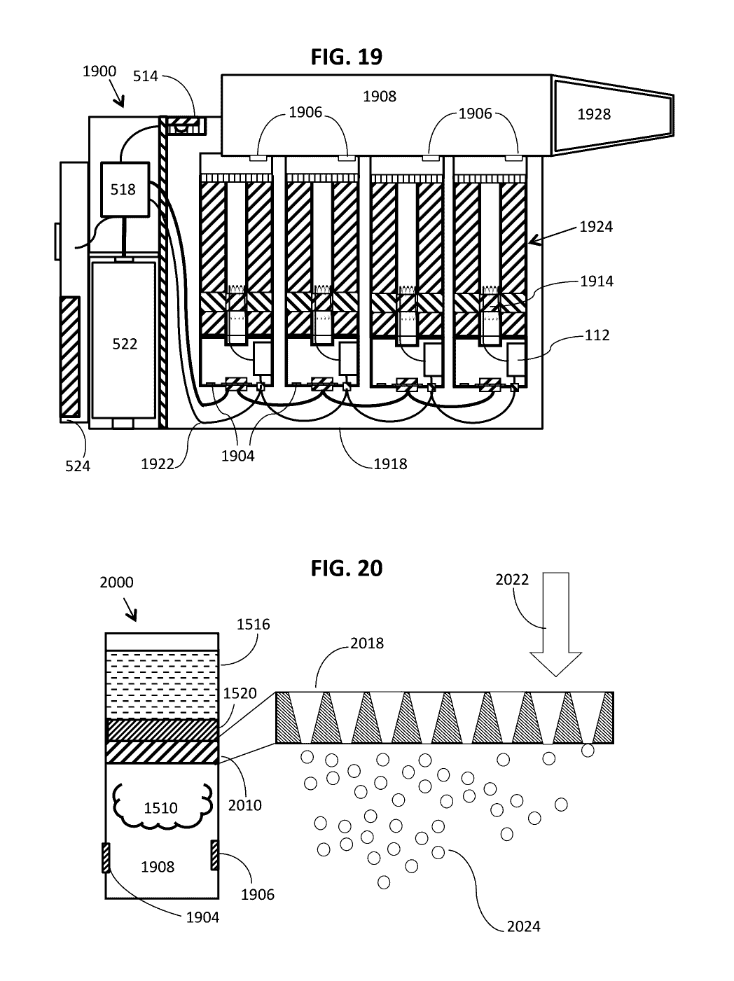

In one embodiment of the invention, a simple heater-coil-based method of implementing the invention will be demonstrated as this is used in typical electronic cigarette implementations. The Vape Device has multiple individually electrically driven coils, each in contact with a separate e-liquid reservoir. The individual e-liquids would each normally contain different flavors. The construction can be serial, as shown in FIG. 5 discussed below, in which the aerosol passes through each e-liquid/coil compartment, the benefit being that multiple flavors can be stacked indefinitely. Alternatively, a parallel construction as shown in FIG. 19 and FIG. 22 below, allows separation of each of the e-liquid and/or flavor compartments and coils. Therefore, it is apparent that the aerosol generated by each of the compartment/coil assemblies can either be mixed by passing through each compartment/coil assembly, or can be mixed in a separate chamber after having been generated and leaving the compartment/coil assembly. While only two embodiments of atomizer construction are shown for the purposes of illustration, it will be apparent to those skilled at the art that there can be many embodiments that retain multiple compartments in which separate flavors or types of e-liquid are contained, together with individually addressable and controllable atomizer components in each compartment (for example, a heater coil or ultrasonic transducer and driver).

For flavor profiles to effectively control the flavor the user is subjected to when using the Vape Device, each atomizer and its corresponding flavor must be able to be identified and linked to the correct flavor on the flavor profile. To implement this, a user can specify the flavor physically loaded on the system manually in order to set up flavor profiles, or the Vape Device or programmable controller can automatically detect the type of flavors that have been physically loaded onto the device. There are several methods that can be used to implement this flavor identification and registration process. Each aerosol-forming substrate (such as an e-liquid) and/or Vape Device may have an identification code, for example a QR code, bar code or numerical code, that can be read either individually or simultaneously (when assembled into a group) by a camera device automatically (such as that on a mobile phone). Alternatively, each aerosol-forming substrate and/or Vape Device can have an electronically readable code, for example, a specific capacitance, resistance or electronic identifier (such as an identifier that can be read out by i2c or SPI bus technology, or a substance which alters the resistance of the e-liquid employed, or by a resistor loaded into the atomizer) which can be read and interpreted by the Vape Device itself, and/or by a device remotely controlling the Vape Device such as a mobile phone, or a color or shape or symbol that can be interpreted by a camera. There may also be a user-readable code that can be entered manually by the user into a user interface on the Vape Device or controlling device. This is not an exhaustive list of methods that allow individual identification and registration of the aerosol forming substrates and/or e-liquid compartment/coil assemblies and/or plurality of atomizers, and those skilled in the art will recognize other methods that can be used to manually or automatically identify each of the aerosol-forming substrates and/or aerosol generators for the purposes of linking the flavor profile to the correct flavors on the device.

In another embodiment, a single unit containing all the individual atomizer compartments which, having a known configuration would have their coils automatically registered at once (rather than individually), which may simplify the construction of the device.

Once each atomizer assembly is registered and aerosol-forming substrates recognized by the programmable controller, the generation of an aerosol mixture corresponding to a flavor profile is implemented by dynamically controlling the aerosol generation intensity of each of the atomizers over time. It will be apparent to those skilled in the art that a neutral or single-flavor aerosol can be generated separately from other flavored aerosols, such that the atomizers can generate a particular flavor mixture of aerosol that is then mixed with the neutral aerosol prior to inhalation by the user. In this way, a user can configure the combination of flavors separately from the overall aerosol flavor intensity if they choose. The type of aerosol can also be selected, allowing the user to select a more humid or thicker aerosol, for example. In the preferred embodiment, individual atomizers that are loaded with aerosol and/or flavoring. Alternatively, there may be more than one flavor per atomizer or vice versa.

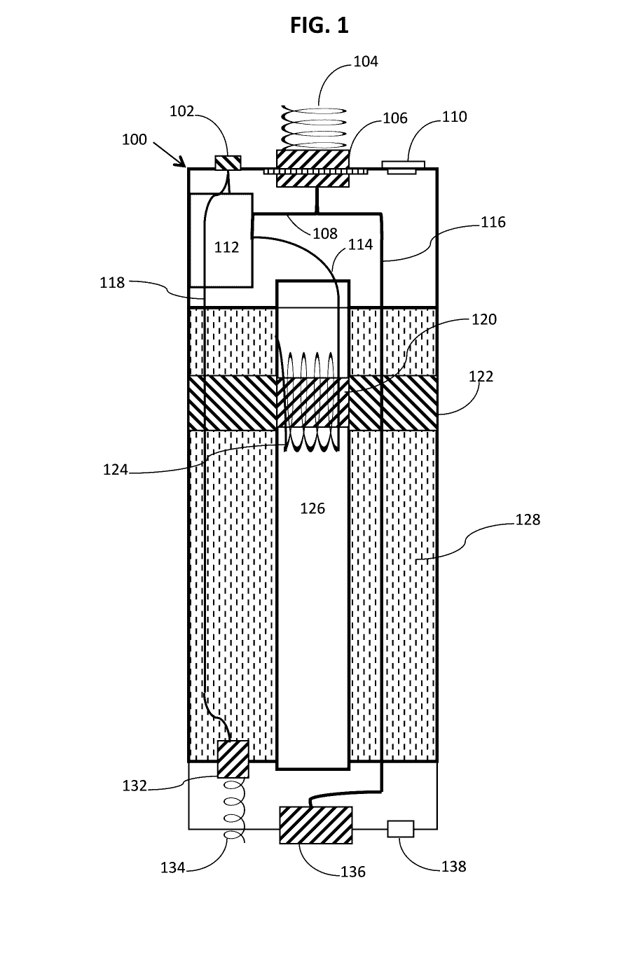

The features and operation of various embodiments of the invention will now be illustrated with reference to FIGS. 1 to 22.

As discussed above, there are several methods by which the controllable atomizer on the Vape Device can be implemented. By controllable, it is meant that the output density of the aerosol, and hence the flavor that a particular atomizer contributes to a drag can be varied.

FIG. 1 is a schematic plan view of a heat-based atomizing module 100 suitable for serial construction embodiment of the invention. The control signal for the atomizer enters via the control pin input 102 and splits into the slave controller 112 and control signal pass-through wire 118 which connects to the control pin output 132 and connector spring 134. The power input connector spring 104 and power input connector 106 splits into a power input wire 108 to slave controller 112 and high current pass through wire 116 which connects to the power output 136. The heater element wire 114 of an individual atomizer is controlled by the slave controller 112 in order to control the intensity of the flavor or aerosol coming out of said atomizer. One or more coils of heat-resistant wire 124, such as is used in heater elements (made of nickel-chromium or other suitable material) are wrapped around an absorbent wick 120, which perpendicularly traverses a small pipe 122 that serves to isolate a compartment which holds the e-liquid 128. When current is passed through the coil 124, it heats up and vaporizes the e-liquid it is in contact with. This is the most common implementation of an electronic cigarette atomizer. By individually varying the intensity of the current through each of the coils in each atomizer chamber 126, contributes a controlled amount of flavoring to the aerosol released. Air (which may include aerosol) enters via an inlet 110 which may include an airflow sensor, passing through the vaporizer chamber 126 to collect the aerosol, and then passing through the outlet 138.

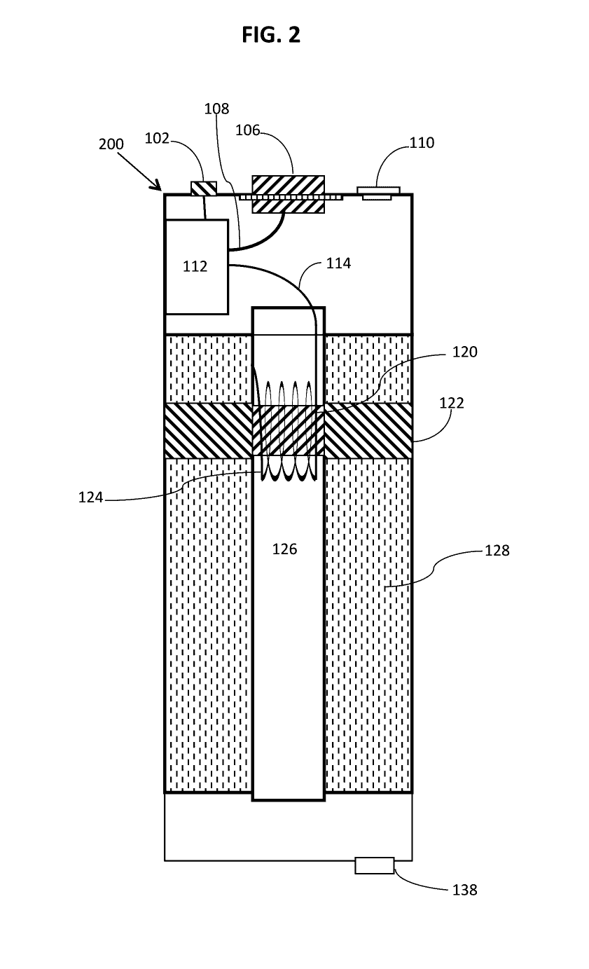

FIG. 2 is a schematic plan view of a heat-based atomizing module 200 suitable for a vaporizer device having a parallel construction in accordance with the invention. Similarly to the atomizing module of FIG. 1, the control signal for the atomizer enters via the control pin input 102 and splits into the slave controller 112. The power input connector 106 (spring omitted) has a power input wire 108 directly connected to the slave controller 112. The heater element wire 114 of an individual atomizer is controlled by the slave controller 112 in order to control the intensity of the flavor or aerosol coming out of said atomizer. One or more coils of heat-resistant wire 124 are wrapped around an absorbent wick 120, which perpendicularly traverses a small pipe 122 that serves to isolate a compartment which holds the e-liquid 128. Air enters via an inlet 110 which may include an airflow sensor, passing through the atomizer chamber 126 to collect the aerosol, and then passing through the outlet 138, preferably into another mixing chamber as per the parallel construction shown in FIG. 19 below.

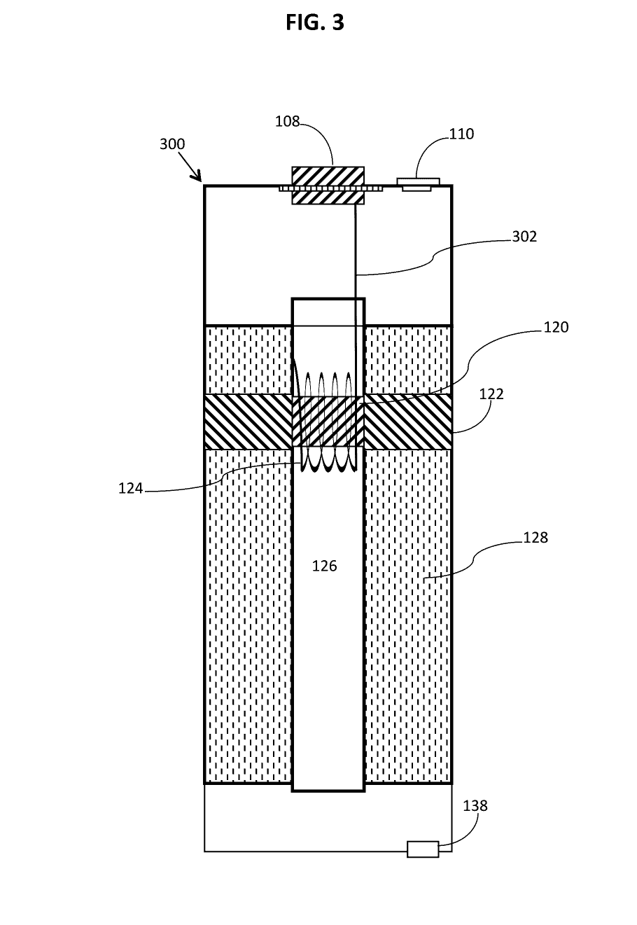

FIG. 3 is a schematic plan view of a heat-based atomizing module 300 with a directly driven element. The power input wire 108 has a heater element wire 302 directly connected to the coils of heat resistant wire 124 which are wrapped around an absorbent wick 120, which perpendicularly traverses a small pipe 122 that serves to isolate a compartment which holds the e-liquid 128. Air enters via the air entry inlet 110 which may include an airflow sensor, passing through the atomizer chamber 126 to collect the aerosol, and then passing through the outlet 138.

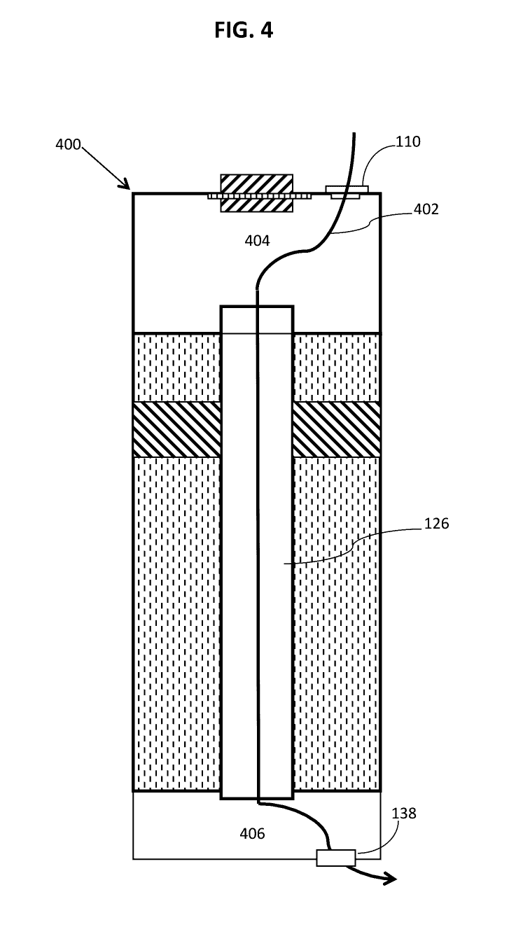

FIG. 4 is a schematic plan view showing airflow 402 through an atomizing module 400 in accordance with an embodiment of the invention. In this embodiment, a user will drag on a mouthpiece (not shown) connected to the outlet 138, whereby the airflow 402 will enter via the inlet 110 into a distal chamber 404 at one end of the atomizing module 400, pass through the atomizer chamber 126 and exit via the outlet 138 in a proximal chamber 406 at the other end. Alternatively, the air inlet could be located in another area such as the proximal chamber 406, although in that case the atomizer chamber 126 should be sealed at the distal end and open at the proximal end.

FIG. 5 is a schematic plan view showing a vaporizer device incorporating heat-based atomizing modules in a serial construction in accordance with an embodiment of the invention. In this embodiment, a Vape Device having atomizing modules in a serial construction 500 has mouthpiece 502 and a plurality of serially arranged atomizing modules (504, 506, 508, 510), preferably each being configured to atomize an aerosol forming substrate having a specific flavor and driven by a slave controller 112. A master programmable controller 518 may drive the operation of the atomizing modules to allow a controlled release of aerosol and each of the atomizing modules (504, 506, 508, 510) have air inlets and outlets to allow passage of the aerosol through them. It will be be recognized by persons skilled in the art that while programmable controllers can be referred to as ‘master’ and ‘slave’, alternative embodiments may incorporate that functionality within a single or multiple programmable controllers. A controllable drag sensor 514 allows air to enter the Vape Device and exit through the mouthpiece 502. This embodiment also includes a push-button interface 520 allowing a user to activate the atomizing modules to produce the aerosol mix. A battery 522 provides power to the master programmable controller 518 and slave controllers 112 which drive the atomizing modules (504, 506, 508, 510). Further, a touch-enabled interface 524 can display the current mode of the electronic and allow a user to manipulate its functionality, including generation of a ‘flavor profile’. Preferably, the touch enabled interface 524 includes a display, such that the user can see which profile is selected, and also view any information such as messages from their phone, who is calling their mobile phone or wearable or messaging them from a social network. The interface or display 524 may also show statistics or a visualization of the popularity of flavor profile they are using.

FIG. 6 is a partial view 600 of the schematic plan of FIG. 5. A master programmable controller 518 provides a power line 604 and control line 608 to power the atomizer (not shown) and slave controller (not shown). A drag sensor wire 612 also may control the controllable drag sensor 514. A user interface line 614 allows communication between the push button interface 520, touch-enabled interface 524, and the master programmable controller 518. A battery power line 610 connects the battery 522 to the programmable controller 518. It will be apparent to those skilled in the art that this arrangement can allow a user to manipulate the power and duration of a plurality of atomizers and also measure and control the level of aerosol flowing through the Vape Device.

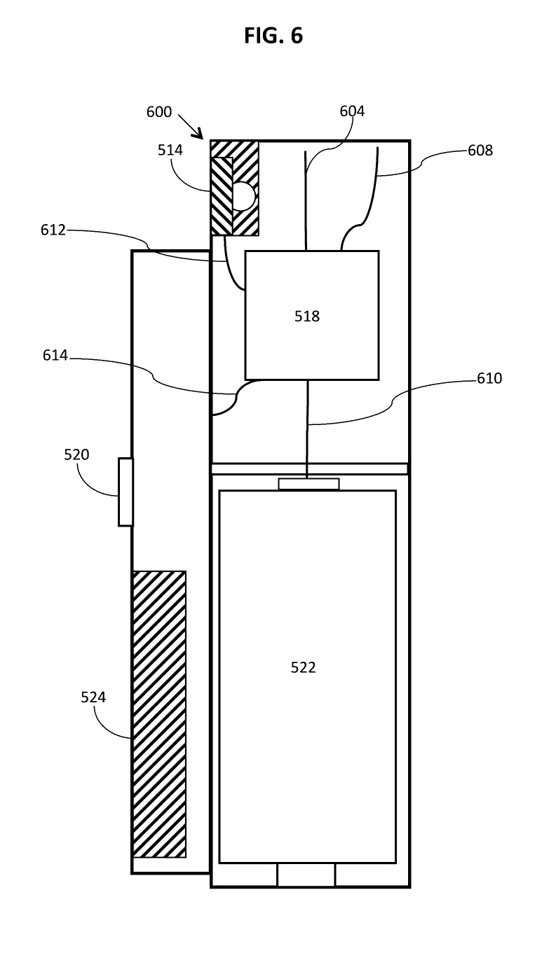

FIG. 7 is a schematic plan view showing an embodiment of the invention with direct element control. A master programmable controller 518 provides a plurality of direct control and power lines 702 to each atomizer (not shown). A drag sensor wire 612 also may control the controllable drag sensor 514. A user interface line 614 allows communication between the push button interface 520, touch-enabled interface 524, and the master programmable controller 518. A battery power line 610 connects the battery 522 to the programmable controller 518. Similarly to the arrangement in FIG. 6, this arrangement can allow a user to manipulate the power and duration of a plurality of atomizers and also measure and control the level of aerosol flowing through the Vape Device.

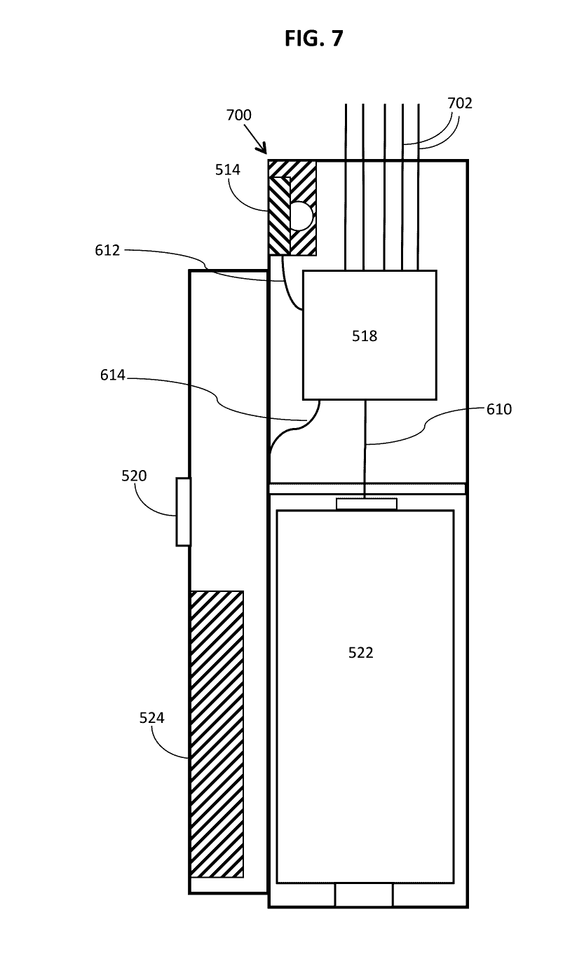

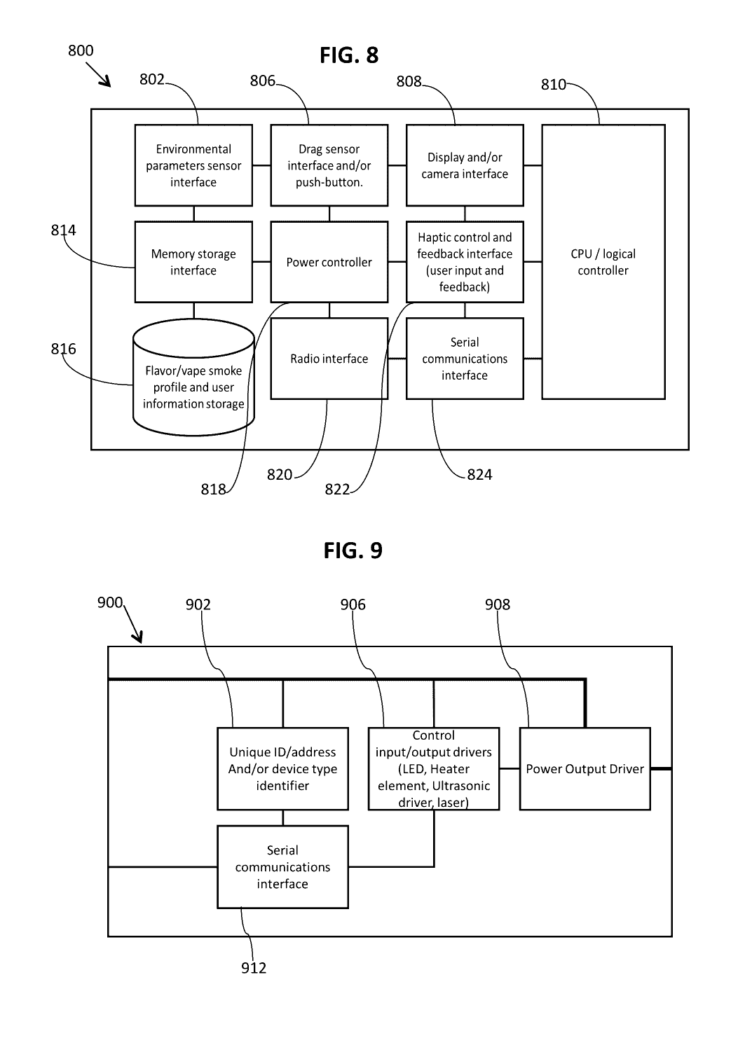

FIG. 8 is a schematic plan view showing the internal functional modules of a programmable controller 800 in accordance with an embodiment of the invention. A CPU/logical controller 810 allows carrying out of encoded instructions and the control of the various modules. For example, an environmental parameters sensor interface 802 may be included which receives input from the environment such as temperature, sound, location, time of day, and other Vape Devices nearby and changes the output to the atomizers in a pre-determined way. For example, in one embodiment, an environmental or external parameter is a music or audio input, either through Bluetooth or a similar wireless connection to the device, or a microphone. The device's CPU/logical controller 810 can then analyze the spectral or temporal content of the music in real-time and adjust flavor parameters to follow the mood of the music. To persons skilled in the art, it will also be apparent that it is possible to provide an application that resides outside of the device which analyses these external influences, and then through direct control of the device through a wireless radio interface connection (see discussion below), instruct the programmable controller 800 to adjust each individual atomizer directly, and in real-time. In another embodiment, the user may select which flavor profile to associate with a particular media file that is playing. In a further and more refined embodiment of this, a user may set cue points in this media file, and select and/or adjust flavor profiles to be applied when that media file is playing on a device that is connected wirelessly to the device. In this way, during the enjoyment of a media file, a user may also enjoy a flavor profile being applied at the correct point. For example, if the user is watching a scene in a movie that is set in a coffee shop, then they would taste the flavor of coffee. In another example, if a user is watching a scene where there is a gunfight, then the user would taste gunpowder through their device at that point in the scene, as long as the atomizers are loaded with the correct flavorings and are correspondingly controlled.

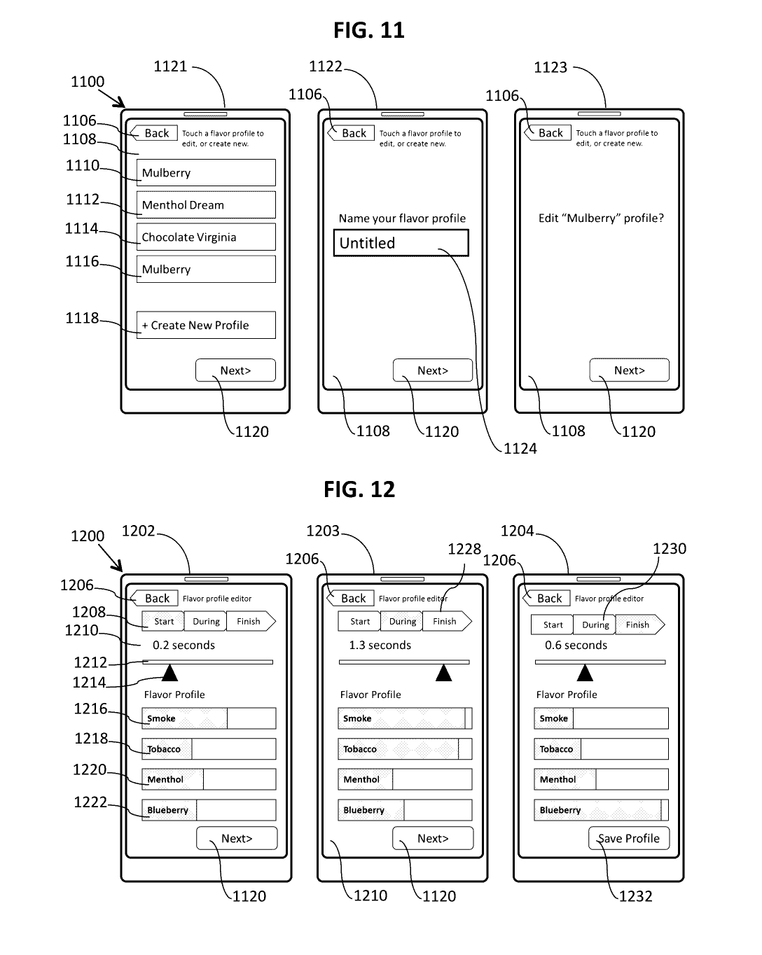

Preferably, a drag sensor and/or push button interface 806 may be provided to receive input from a drag sensor and/or push button or other human interface device in order to control the parameters of a flavor profile and/or activate the atomizer. A display and/or camera interface 808 can be used to interface a display that presents information to a user or receives information such as the user interfaces shown in FIGS. 11 and 12. The interface 808 may also receive communicate with a camera to receive information from the environment, including reading from 2D barcodes and the like. A memory storage interface 814 can be used to interface with the flavor profile and user information storage 816 which comprises volatile or non-volatile memory to store data received, including information regarding previously saved flavor profiles and the ratings assigned to them by a user. A power controller 818 can be used to control the driving of power from the battery to atomizers and other parts of the Vape Device.

A radio interface 820 allows wireless communication, such as via a 2.4 Ghz Wifi, Bluetooth unit, or GSM. Preferably, the programmable controller 800 is also able to analyze the level of e-liquid or consumable in the device that remains, and interpolate this so that the controller 800 can notify the user or re-order consumables when the e-fluid or any other consumable on the device will run out. Since this information is known by the controller 800, and since the controller 800 can be connected to an online service (not shown) via the radio interface 820, it is possible that the user can be prompted to re-order e-liquid or other consumables (flavors, aerosol liquid, e-liquid, coils and coil compartments, batteries). The user can also opt for these consumables to be automatically purchased and shipped to a preferred address either before or after the consumables expire (coils, batteries) or run out (e-liquid, flavors).

Preferably, the programmable controller 800 also contains a haptic interface 822 such that the user can receive tactile feedback on their drag, for example, using a current to stimulate the hand that is holding the Vape Device, or a buzzer motor, or a notification method to the display, or by lighting a series of lights in sequence depending on the strength and/or length of the inhalation through the Vape Device. A serial communications interface 824 can also be provided in order to facilitate communication between the various modules and the other parts of the Vape Device, including slave controllers and atomizers (not shown).

FIG. 9 is a schematic plan view of the slave circuit controller 900 in accordance with an embodiment of the invention. Preferably, a unique id/address and/or device type identifier is provided which allows the identification of the device and/or any substrates that are loaded into the Vape Device, such as e-liquids. Preferably, the substrates include some means of allowing such identification, for example, 2D barcodes, or electric resistance profile. A control input/output driver 906 allows control of the various atomizers including heater, laser, LED or ultrasonic elements. The power output driver 908 ensures that the correct power output is applied to the atomizers and a serial communications interface 912 facilitates communication with the programmable ‘master’ controller 800 and the various modules of the slave circuit controller 900.

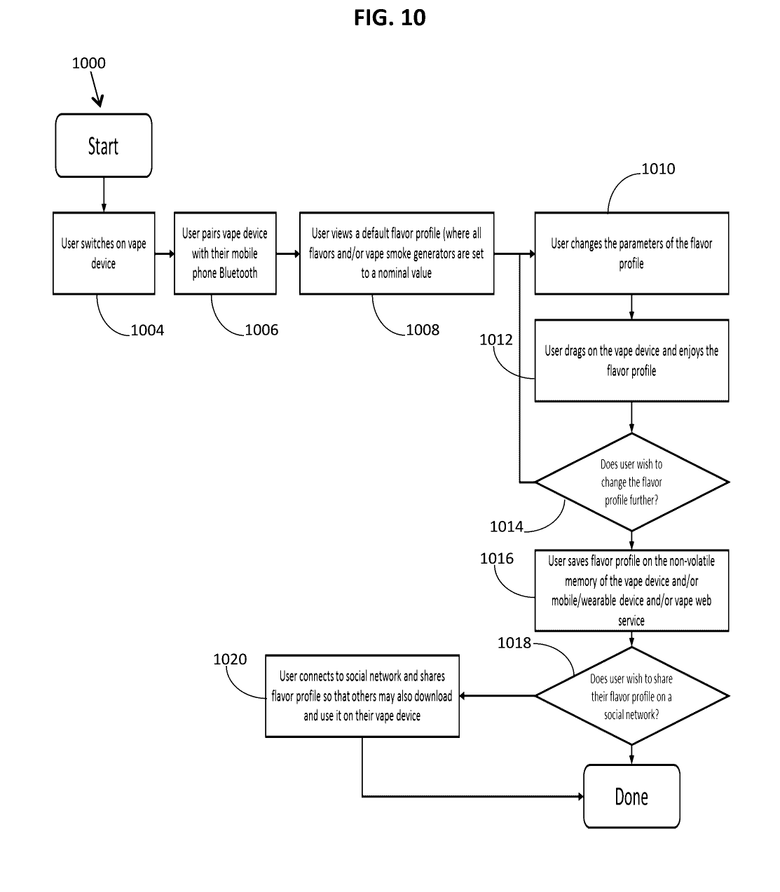

FIG. 10 is a flow diagram of an exemplary process 1000 whereby a user may generate and share a flavor profile in accordance with an embodiment of the invention. In the first step 1004 the user switches on the Vape Device. In the next step 1006, the user pairs the Vape Device with their mobile phone Bluetooth. In the next step 1008, the user views a default flavor profile (where all flavors and/or vape smoke generators are set to a nominal value). In the next step 1010, the user changes the parameters of the flavor profile. At the next step 1012, a user may drag on the Vape Device and enjoy the flavor profile generated. After this step 1014, if a user would like to change the flavor profile further they may return to step 1010. Otherwise, they may proceed to the next step 1016, whereby the user saves the flavor profile on the non-volatile memory of the Vape Device and/or mobile/wearable device and/or web service. At the next step 1018, a user is asked whether they wish to share their flavor profile on a social network. If so, at this step 1020, a user may connect to a social network and share the flavor profile so that others may also download and use it on their Vape Device. Otherwise, the process is finished.

FIG. 11 is an illustration of an exemplary user interface 1100 showing how a user may browse, edit or create a flavor profile in accordance with an embodiment of the invention. Although the user interface shown is a touch screen 108 of a mobile device 1122, preferably a user is able to select a flavor profile through a wearable, mobile or web application interface and either have the device control the Vape Device, or load and/or select the flavor profile on the Vape Device. The user may also be able to create and/or edit flavor profiles through said device user interfaces, and/or the flavor profile may adjust itself depending on external parameters. In the first screen 1121 of the exemplary user interface shown 1100, a user may select from a range of pre-loaded flavor profiles (1110, 1112, 1114, 1116) or they may select creating a new flavor profile 1118. The user interface also provides a forward button 1120 allowing a user to move to the next screen or a back button 1106, which returns to the previous screen. In the next screen 1122, assuming a user has chosen to create a new flavor profile, they are provided a field 1124 allowing them to name the flavor profile. Alternatively, in the next screen 1123, a user has chosen to edit an existing “Mulberry” flavor profile.

FIG. 12 is an illustration of an exemplary user interface 1200 showing how a user may adjust the intensity and duration of atomization of a plurality of flavored substrates to generate a new flavor profile in accordance with an embodiment of the invention. In particular, if the aerosol and/or flavor vaporizer output can be controlled temporally, it is possible to dynamically alter the flavor the aerosol has even throughout the course of a single ‘drag’ that the user makes. As noted above, this is called the ‘flavor profile’, where each atomizer is individually subject to a varying control current across the period of a drag, thereby controlling the flavor and/or aerosol profile throughout the drag the user makes. By way of example, FIG. 12 assumes that a user in FIG. 11 wishes to edit a particular flavor profile. In the first edit screen 1202, a user can select a button 1208 to edit the flavor profile at the start of the drag. Preferably, the time from the start of the drag can be displayed 1210 in seconds and a user has a scroll bar 1212 and indicator 1214 which allows a user to select at what stage of the drag (in seconds) they wish to adjust the relative flavors. The flavor bar indicators (1216, 1218, 1220, 1222) allow a user to adjust the relative intensity of atomization of those flavored substrates at that point in time. It should be acknowledged that although the adjustment of particular flavors may provide an aesthetically pleasing experience it is also possible that the substrates have specific pharmacological properties and may therefore provide various therapeutic effects according to their relative level of atomization in an aerosol mixture. Therefore, the term ‘flavor’ is not restricted to merely the aesthetic experience. In the next screen 1203, a user has selected a button 1228 to adjust the flavor profile at the finish of the drag. In the next screen 1204, the user has selected a button 1230 to adjust the flavor profile during the middle of a drag. Finally, a user may press the save profile button 1232, which saves this particular flavor profile into memory under the name chosen in the previous FIG. 11.

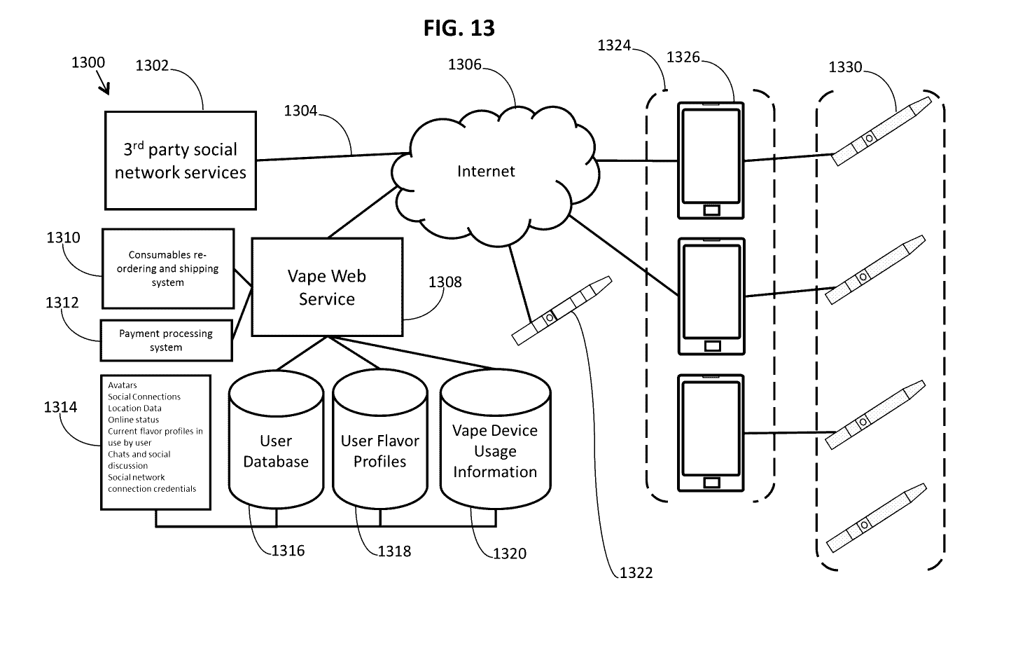

FIG. 13 is a schematic representation of a network system 1300 allowing communication between programmable vaporizer devices (1322, 1330) and various services over the Internet 1306 in accordance with an embodiment of the invention. Preferably, a Vape Web Service 1308 can act as a proxy for exchanging flavor profile information between Vape Devices (1330, 1322) and/or Vape Device Controllers 1326 (preferably though a wireless connection and communications protocol, such as WiFi, Bluetooth, GSM/LTE or another wireless protocol, but alternatively through a wired communications protocol such as USB, Thunderbolt, Ethernet) such that it would be easier for a user to manipulate, tag, share or load flavor profiles onto a Vape Device. In a further embodiment, the Vape Device itself may communicate with third party social network services 1302 (such as Twitter, Facebook, Google Plus, WhatsApp and other such services which may from time-to-time become available or vape flavor profile sharing services), either directly or through a combination of the Vape Device Controllers 1326 (including but not limited to the users' mobile phone device or wearable or tablet) and Vape Web Service 1308 via the Internet 1306, such that flavor profile and Vape Device usage profile for a user and/or for a flavor profile can be shared across these networks with other users. Preferably, the Vape Web Service 1308 is a computing system that is comprised of a CPU, memory system and network communication controller to form a network data server. A software application runs on the computing system that gives rise to the Vape Web Service, such that the Vape Device can communicate (directly or indirectly through a Vape Controller) with the Vape Web Service, such that it may query it to download or upload flavor profiles to Vape Devices (1322, 1330) via the Internet 1306.

Preferably, the system 1300 allows a user can share their flavor profiles and any external information relevant to that flavor profile, for example, cue points in certain media files for flavor profile control, online or on remote storage, and/or in the manner of a social network. In particular, the user will be able to share flavor profiles with other registered users on the network, either privately on a one-on-one basis, in real-time while they are enjoying a flavor profile, based on their location and proximity to other users that are using Vape Devices that offer dynamic flavor control, or more generally on a public forum.

In this embodiment, it is shown that a Vape Device can send vape device usage information directly to the Vape Web Service which is stored in a memory 1320, such that the Vape Web Service can determine when the user has run out of a consumable or is about to run out of a consumable such that the user can be prompted if they would like to purchase a consumable that is finishing, or can suggest a flavor profile to a user and effect a shipment of consumables related to that flavor profile (such as e-liquid, flavored and unflavored aerosol, flavorings, atomizer components, batteries, cleaning products, pre-loaded atomizer modules) via a consumables reordering and shipping system 1310. The user can select for consumables to be automatically sent to them if they choose—payment would be taken automatically by the Payments Processing System 1312 (payment being through any mechanism possible—for example, credit card, direct bank payment, cryptocurrency, voucher or points system) and preferably a shipment notification is then sent to a user together with tracking information. Preferably, the consumables re-ordering and shipping system 1310 will use predictive analytics to determine when a user will run out of a consumable, but may also query or take information directly from a Vape Device (1322, 1330) or Vape Device Controller 1326 about the status of one or more consumables in use on the Vape Device. The Vape Web Service 1308 will also store user information in a user database 1316 and also store information regarding user flavor profiles 1318.

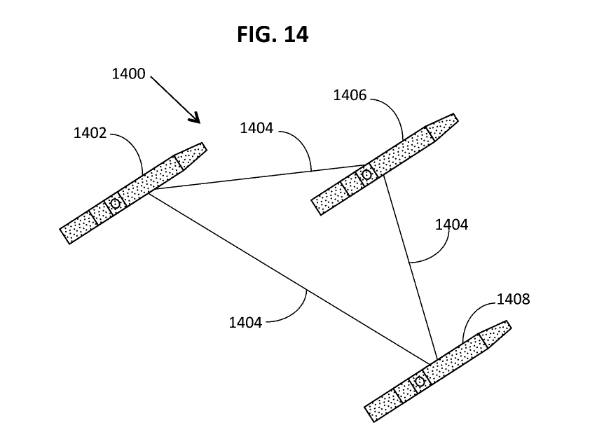

FIG. 14 is a schematic representation of a peer-to-peer system 1400 allowing direct communication between Vape Devices (1402, 1406, 1408) in accordance with an embodiment of the invention. In another embodiment, Vape Devices can communicate data 1404 directly with each other, including but not limited to flavor profile information such that it is possible to obtain a flavor profile wirelessly and directly from one Vape Device to another. For example, a Vape Device may elect to communicate directly to other proximal Vape Devices in a peer-to-peer manner, and transmit flavor profiles and Vape Device usage information. A Vape Device 1402 can send a flavor profile to a second Vape Device 1406, which can send this on to another Vape Device 1408. In this manner, a user can share their vape profile without the use of an intermediary web service or remote device. Users can set up their Vape Devices to share any flavor profiles and their usage to any Vape Device that is proximal, or can share in an ‘invite-only’ manner, where there is a security layer that prevents this sharing of the flavor profiles stored in non-volatile memory on the Vape Device unless the user of said Vape Device allows other Vape Devices to access the flavor profiles.

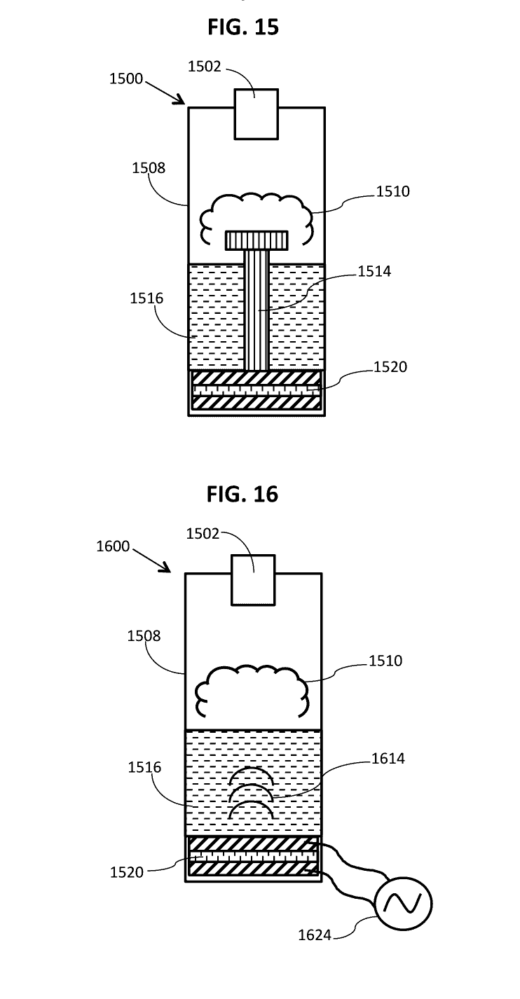

FIG. 15 is a schematic plan view of an ultrasonic atomizer 1500 using an ultrasonic coupling device in accordance with an embodiment of the invention. In particular, an ultrasonic actuator is used to directly vaporize the e-liquid in the manner of a medical nebulizer. This can operate using a piezoelectric transducer module 1520 which acts upon the e-liquid 1516 itself and causes atomization, magnetic coil driver (solenoid) and a sonotrode 1514. The frequency of the piezoelectric transducer is between 15 KHz and 500 KHz, preferably 115 KHz +/−50 KHz but also dependent on the composition of the e-liquid 1516 and construction of the chamber 1508 where the piezoelectric transducer 1520 is in contact with the sonotrode 1514 and the e-liquid 1516. It would be recognized by a person skilled in the that a sonotrode 1514 can have various shapes including a rod, a flat plate, a patterned plate, a sphere or elliptical structure, concave or convex, and there may be a plurality of these shapes actuated ultrasonically. Preferably, the aerosol 1510 is comprised of droplets preferably generated to be from 0.001 micrometers to 20 micrometers in diameter, a typical frequency for the ultrasonic actuator to effect this being from 15 KHz-500 KHz. The aerosol 1510 is ejected into a chamber 1508 through the action of ultrasonic energy onto the substrate itself, not via any heating effect, and this has the added benefit of not introducing any heat-related chemical change to the e-liquid, so that more sensitive flavors or heat-sensitive chemicals can be effectively utilized in the atomizer. Preferably, the atomizer 1500 is configured so that in operation, a user can inhale the aerosol 1510 through an outlet 1502.

FIG. 16 is a schematic plan view of an alternative ultrasonic atomizer 1600 in accordance with an embodiment of the invention. In this particular embodiment, the sonotrode is absent, and the piezoelectric transducer module 1520 produces an ultrasonic wave force 1614 directly on the e-liquid 1516 in order to produce an aerosol 1510 within a chamber 1508, which can be inhaled through an outlet 1502. Preferably, the motion of the piezoelectric transducer 1520 is substantially sinusoidal 1624.

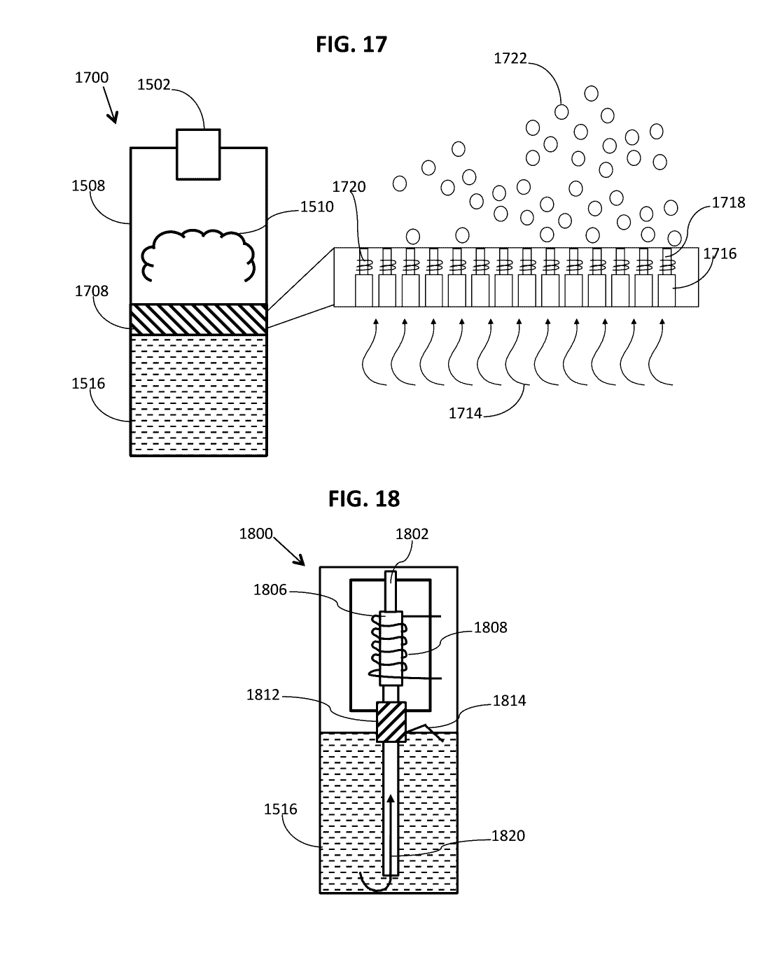

FIG. 17 is a schematic plan view of a thermal inkjet-style atomizer 1700 in accordance with an embodiment of the invention. In this particular embodiment, the e-liquid 1516 is converted into an aerosol 1510, by the thermal inkjet module 1708. The process by which a liquid is converted into an aerosol by a thermal inkjet process is known by those skilled in the art. In particular, the e-liquid 1516 by means of a pump (not shown) is pushed through 1714 a plurality of small holes 1716 and out of a nozzle 1718 which heats the e-liquid using an element 1720, and such e-liquid thermally ejected as small bubbles 1722 in the manner of a inkjet printer, in order to form an aerosol 1510 into a chamber 1508 which can be inhaled through an outlet 1502.

FIG. 18 is a schematic plan of a microfluidic atomizer 1800 in accordance with an embodiment of this invention. In particular, shows a heated chamber 1806 manufactured from a metal, ceramic, heat-resistant plastic, glass or other material that can withstand heat, and heated by a heater element comprising heat-resistant wire 1808, which is used to vaporize the e-liquid 1516, whereby the use of a microfluidic pump 1812 the e-liquid is pumped into the heated chamber 1804, and when the liquid contacts the heated chamber walls, it is immediately vaporized and ejected from the top nozzle 1802 of the heated chamber. The pump 1812 is driven by power input 1814 and can be ultrasonically actuated, MEMS actuated, thermally actuated, a magnetofluidic pump or any alternative mechanism that can move the e-liquid in a controlled manner into the heated chamber 1806. The ‘smoke machines’ used in theatrical events and festivals operate according to a similar mechanism.

FIG. 19 is a schematic plan of an embodiment of a vaporizer device 1900 incorporating the heat-based atomizing modules of FIG. 2 in a parallel construction. Preferably, in this construction the vaporizer device incorporates the atomizing module 1924 as shown in FIG. 2. A master controller 518, powered by a battery 522, has connections 1922 to drive the power input and control of the slave controllers 112, and ultimately drive the heating element 1914 to allow atomization of the flavored substrates. The master controller 518 could be manipulated by a user in accordance with a touch-enabled interface 524. A controllable drag sensor 514 allows ingress of air, which flows into an inlet 1904 through the atomizing module 1924 and out of an outlet 1906 into a mixing chamber 1908, which will preferably receive aerosol substantially corresponding to a particular flavor profile when the Vape Device 1900 is in operation. A user would then inhale the aerosol produced using a mouthpiece 1928.

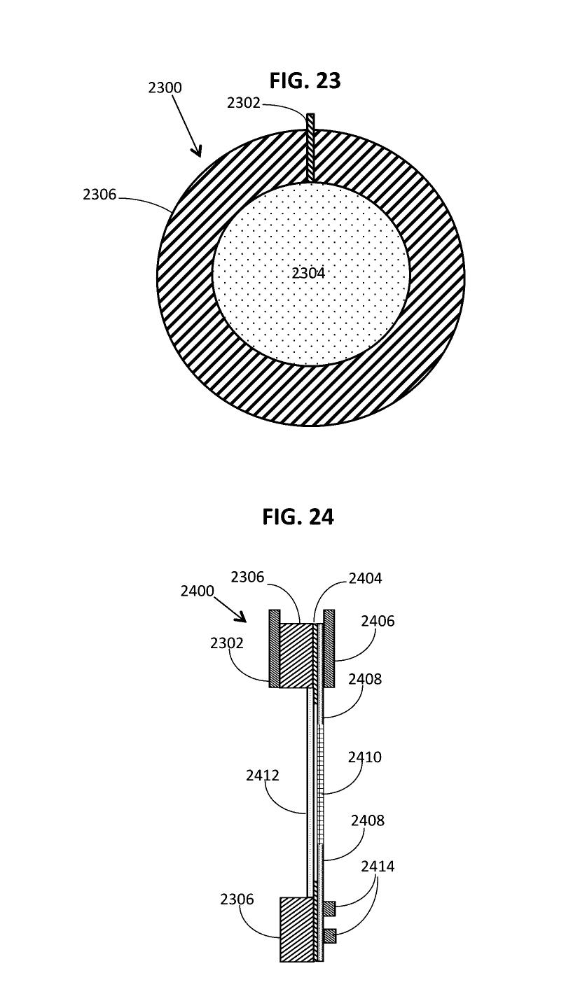

FIG. 20 shows an ultrasonic mesh implementation of an atomizer 2000 whereby the e-liquid 1516 is in contact with an ultrasonic transducer 1520 and mesh 2010, said mesh having holes 2018 that are of a size that through surface tension prevent the e-liquid 1516 from passing through. The e-liquid is vaporized into an aerosol 1510 through the process of acoustic droplet ejection from the holes 2018 and/or surface of the mesh 2010, when e-liquid is present on the feed side of the mesh. Although mesh is described, this can be implemented in many forms, for example, a rod, a flat plate, a patterned plate (micro-patterned such that its surface is designed to optimally eject fluid particles from its surface) a sphere or elliptical structure, concave or convex, and there may be a plurality of these shapes actuated ultrasonically. Droplets 2024 are generated to be from 0.001 micrometers to 40 micrometers in diameter, a typical frequency for the ultrasonic transducer 1520 to effect this being from 15 KHz-500 KHz. In this embodiment, the e-liquid is pushed onto the mesh due to the force of gravity 2022, droplets 2024 are ejected through the action of ultrasonic energy onto the mesh 2010 itself, not via any heating effect. This has the added benefit of not introducing any heat-related chemical change to the e-liquid, so that more sensitive flavors or heat-sensitive chemicals can be effectively utilized in the atomizer having this embodiment. The aerosol 1510 is formed within the mixing chamber 1908 connected to an inlet 1904 and outlet 1906. The preferred operation and construction of the mesh 2010 will be described below in more detail with reference to FIGS. 23 and 24.

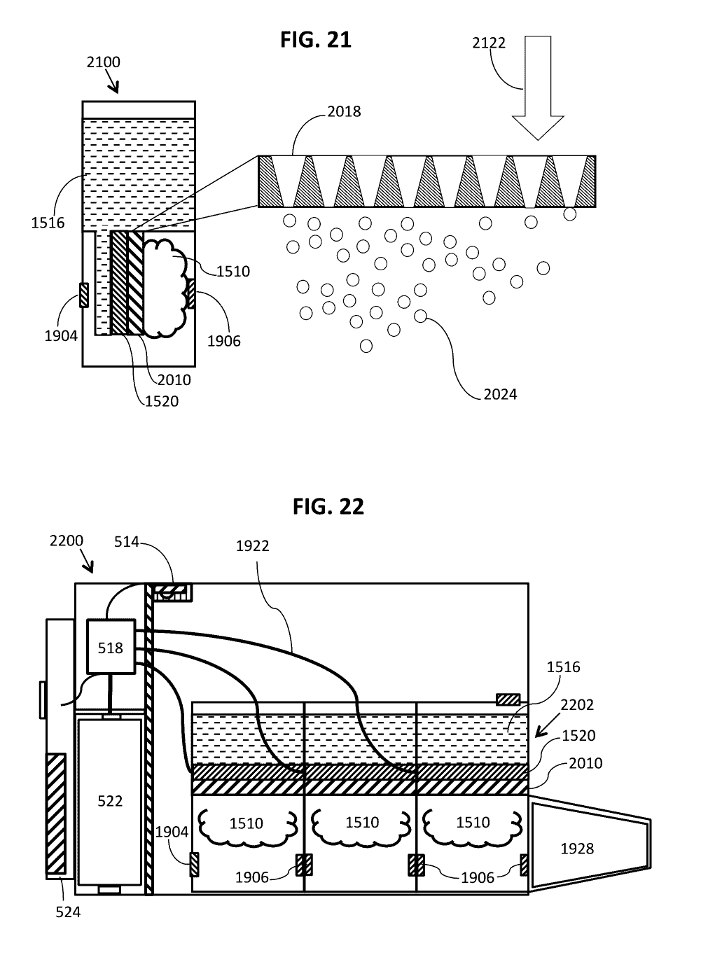

FIG. 21 is a schematic plan of a vertical ultrasonic mesh atomizer 2100 in accordance with an alternative embodiment of the invention. This is a similar construction to the atomizer of FIG. 20, but with the ultrasonic transducer 1520 and mesh 2010 in a vertical orientation. The e-liquid 1516 is pressed against the ultrasonic transducer 1520 due to pressure 2122 caused by the force of gravity on the e-liquid. Droplets 2024 are formed when the e-liquid passed through through holes 2018 in the surface of the mesh 2010.

FIG. 22 is a schematic plan of an embodiment of a vaporizer device 2200 incorporating the non-heat-based ultrasonic mesh atomizer modules of FIG. 20 in a parallel construction. Preferably, a master controller 518, powered by a battery 522, has connections 1922 to drive the power input and control of the ultrasonic transducer 1520 to allow atomization of the e-liquid 1516. The master controller 518 could be manipulated by a user in accordance with a touch-enabled interface 524. A controllable drag sensor 514 allows ingress of air, which flows into inlets 1904 through the ultrasound atomizing module 2202 and via several outlets 1906, and into the mouth of an inhaling user via a mouthpiece 1928.

FIG. 23 is a schematic top view of an ultrasonic mesh assembly 2300 in accordance with an embodiment of this invention. Preferably, a piezoelectric ultrasonic transducer 2306 driven by an electrode 2302 vibrates an ultrasonic mesh 2304 at a high frequency, which is used to atomize the e-liquid pressing against the mesh. In the example embodiment, the ultrasonic mesh 2304 is preferably made from a perforated nickel-palladium metal plate, or similar material that has a low modulus of elasticity and therefore allows more efficient operation of the atomizer. The perforated material may also be a plastic or ceramic substance, which may reduce costs in manufacture, or allow for other improvements - for example, higher density of perforations or more efficient ultrasonic coupling. Those skilled in the art will realize that there may be a plurality of perforated layers within the vibrating ultrasonic mesh assembly 2300, or that the assembly may have an alternate construction, for example, a square plate, or it may have a plurality of ultrasonic actuators, and that these may be open, that is that the transducer 2306 does not have a closed area of plate at its center, or closed, as indicated in the figure, where the transducer 2306 is an annular ring with the mesh 2304 at its center.

FIG. 24 is a schematic side view of an ultrasonic mesh assembly 2400 in accordance with an embodiment of this invention. The mesh portion of the assembly includes a fine mesh 2412 and filter mesh 2410 on the opposite side. A spacer 2404 is located between the annular piezoelectric ultrasonic transducer 2306. Preferably, the mesh assembly component incorporates a heater 2408 to warm the e-liquid prior to it coming into contact with the perforated mesh, or will incorporate a heater directly in contact with the perforated mesh. This heater 2408, driven by electrodes 2414 is not used to atomise the e-liquid, but to warm it in order to reduce the viscosity of more viscous e-liquid substrates, making it possible for these liquids to be atomised by the ultrasonic mesh. In the example embodiment, the perforated mesh has a diameter size of perforations between 0.3-75 micrometers, and these perforations are preferably shaped on both sides using electroforming or laser-drilling techniques, as demonstrated in U.S. Pat. No. 6,235,177, hereby incorporated by reference. This allows for creation of aerosol droplets that have a diameter of less than 50 micrometers, preferably 0.2 micrometers to 25 micrometers. The ultrasonic mesh may vibrate at a frequency of between 1 and 500 KHz, preferably at approximately 128KHz, with an overall duty cycle of the power driver being between 0.1% and 100% in order to control the quantity of the atomized aerosol particles generated. It is also possible to configure the assembly 2400 to sense whether it is in contact with any e-liquid, as the transducer 2306 will have a distinct resonant frequency characteristic if it is not in contact with the e-liquid, but will not have such a resonant frequency if it is in contact with e-liquid, as the e-liquid will critically damp the resonance. This can be sensed by measuring the frequency that is used to drive the transducer 2306 between two ranges and monitoring the change in impedance. For example, when the transducer 2306 is resonating, the impedance will peak sharply and this can be detected by a current sensor (not shown) or by monitoring the voltage across the transducer 2306, or by the phase relationship between voltage drive and current into the transducer 2306. For example, if the transducer 2306 has a natural resonant frequency of 126 KHz, this will be detected by a frequency sweep covering the ranges between 15-500 KHz and searching for a peak in impedance. If no such peak is found, then the transducer 2306 is in contact with e-liquid and can continue to be driven. If a peak is found, the device CPU can indicate that the particular reservoir feeding the ultrasonic mesh is empty, and the CPU can correspondingly limit or shut down the drive signal to that particular ultrasonic mesh preventing damage to the transducer 2306 (by overheating or mechanical damage), and also informing the user that the reservoir is empty and requires refilling.

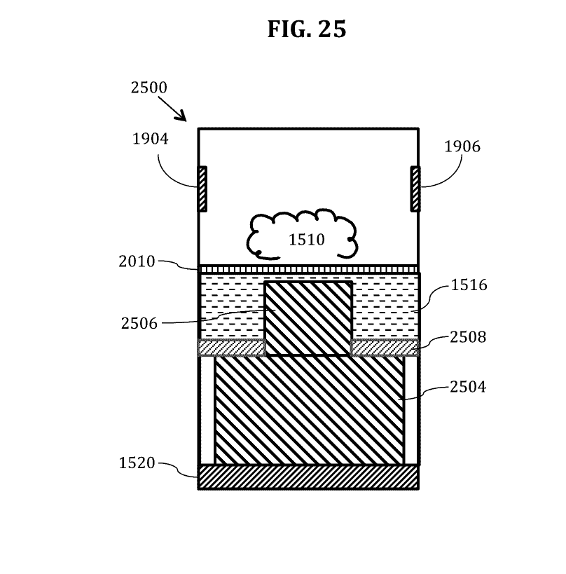

FIG. 25 is a schematic plan view showing an alternative ultrasonic horn atomizer 2500 with mesh 2506 in accordance with a preferred embodiment of the invention. The ultrasonic transducer 1520 drives an alternative sonotrode body 2504 extending a sonotrode tip 2506 through a seal 2508 into a reservoir of e-liquid 1516. The application of ultrasonic waves from the sonotrode on the e-liquid immediately adjacent to an ultrasonic mesh 2010 atomizes the e-liquid creating an aerosol 1510. Preferably, the ultrasonic mesh 2010 has an electrical charge, which ensures that droplets forming aerosol 1510 have the same charge and are electrostatically repelled from the other side of the mesh 2010. An air inlet 1904 and outlet 1906 allow the aerosol to be inhaled by a user. This particular construction of atomizer having a combination of a sonotrode body 2504 with a flat sonotrode tip 2506 immediately adjacent to an ultrasonic mesh 2010 is preferred because it generates a significantly greater amount of aerosol than other kinds of ultrasonic atomizers that do not have this combination.

It will be appreciated by those skilled in the art, that there are a variety of alternate methods to generate atomized e-liquid in a controlled manner, and that the general principal of atomization that is described in this invention can have different implementations from those disclosed in this specification.

In an alternative embodiment (not shown), a semiconducting laser diode with a power of between 100 miliwatts and several Kilowatts (either in a q-switched or pulsed mode, or continuous wave) is used to directly impinge onto an absorbent surface that is saturated in e-liquid, heating it and vaporizing the e-liquid. This absorbent surface can be made from any material that wicks and absorbs the e-liquid, presenting it for irradiation by said laser, for example, porous ceramic, sintered metal, carbon rod, fiberglass, carbon fiber, fine glass rod.

In another alternative embodiment (not shown), the Vape Device is able to passively emit aerosol either during or between drags, in a similar manner to a traditional combustible cigarette, the benefit being that this passive emission makes the experience of vaping similar to that of smoking a cigarette. The passive emission of this atomized vape ‘aerosol’ (the amount of aerosol, the timing of the emission and the duration of emission) is controlled by parameters that are stored in the programmable controller or CPU, and these parameters can be set through the local tactile interface on the Vape Device, or through an application or web service that communicates to the programmable controller or CPU. Such passive emission will not be appropriate where the Vape Device is configured to atomize a substrate having therapeutic properties such as a medicament.

Where the Vape Device is configured to deliver a medicament, reference to flavors of substrates here corresponds to different medical or excipient properties. Preferably, the

Vape Device can be configured so that the user has limited control over the atomization of particular substrates to ensure they are not receiving an incorrect dose. Haptic, aural, or visual notifications may be sent to a user in order to remind them of the time and/or date they must receive a dose of medicament and for how long to inhale the aerosol. In this way, a dosing regime can be precisely indicated. Preferably, information regarding use of the Vape Device and inhalation of medicament is sent to a remote server so that it can form part of a user's electronic medical records.

While the invention has been illustrated and described in detail in the foregoing description, such illustration and description are to be considered illustrative or exemplary and non-restrictive; the invention is thus not limited to the disclosed embodiments. Features mentioned in connection with one embodiment described herein may also be advantageous as features of another embodiment described herein without explicitly showing these features. Variations to the disclosed embodiments can be understood and effected by those skilled in the art and practicing the claimed invention, from a study of the disclosure and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1. A programmable vaporizer device comprising:
a plurality of aerosol-forming substrates having different flavors;
means for atomizing said substrates within at least one chamber;
a power supply configured to power said means for atomizing said substrates;
at least one air inlet and outlet in communication with said chamber;
a programmable controller directly or wirelessly connected to said means for atomizing said substrates and configured to atomize said substrates using a pre-determined intensity and duration of atomization over time to generate an aerosol mixture corresponding to at least one flavor profile;
means for activating said programmable controller to generate said aerosol mixture within said chamber which can be inhaled by a user from the outlet.

2. The vaporizer device of claim 1, wherein said programmable controller includes a user interface allowing a user to generate a new flavor profile by specifying the intensity and duration of atomization of said substrates over time.

3. The vaporizer device of claim 1, further comprising a communications link with a remote host configured to download at least one said flavor profile to said programmable controller and upload at least one said flavor profile or vaporizer device usage information to the remote host to share with other users.

4. The vaporizer device of claim 1, further comprising a communication link with at least one other vaporizer device allowing the exchange of at least one said flavor profile.

5. The vaporizer device of claim 1 wherein said programmable controller includes means for detecting the duration and/or force of inhalation by said user.

6. The vaporizer device of claim 1, wherein said programmable controller is configured to adjust the flavor profile in a pre-determined manner in accordance with duration and/or force of inhalation by said user.

7. The vaporizer device of claim 2, wherein said user interface includes touch-enabled surface means or push-button means allowing a user to specify the intensity and duration of atomization of said substrates over time.

8. The vaporizer device of claim 1, wherein said programmable controller adjusts the flavor profile in accordance with external parameters in a pre-determined manner, said external parameters including specific environmental cues.

9. The vaporizer device of claim 1, wherein said programmable controller includes a haptic interface configured to provide a user with haptic feedback in response to use of the vaporizer device.

10. The vaporizer device of claim 1, wherein said aerosol-forming substrates include means for allowing identification of the individual composition of those substrates.

11. The vaporizer device of claim 1, wherein said aerosol-forming substrates comprise liquid substrates.

12. The vaporizer device of claim 11, wherein said liquid substrates comprise one or more of glycerine, propylene glycol and nicotine.

13. The vaporizer device of claim 1, wherein said aerosol-forming substrates are solid substrates such as tobacco or dried herbal material.

14. The vaporizer device of claim 1, wherein said aerosol-forming substrates comprise compounds having a therapeutic or psychological effect.

15. The vaporizer device of claim 1, wherein said means for atomizing said liquid substrates comprise means that do not use heat including an ultrasonic actuator and/or ultrasonic mesh.

16. The vaporizer device of claim 15, wherein said ultrasonic mesh includes means for heating a liquid substrate to reduce its viscosity.

17. The vaporizer device of claim 11, wherein said means for atomizing said liquid substrates comprise an ultrasonic actuator coupled to a sonotrode extending into said liquid substrate and combined with an ultrasonic mesh.

18. The vaporizer device of claim 1, wherein said means for atomizing said substrates comprise means that use heat including a heated coil, conduction atomizer, or convection atomizer.

19. The vaporizer device of claim 1, wherein said means for atomizing said substrates are connected to said chamber in a serial configuration.

20. The vaporizer device of claim 1, wherein said means for atomizing said substrates are connected to said chamber in a parallel configuration.

21. A method of generating a flavor profile on a programmable vaporizer device including the steps of:
providing a plurality of aerosol-forming substrates having different flavors;
providing means for atomizing said substrates within at least one chamber;
providing at least one air inlet and outlet in communication with said chamber;
providing a programmable controller directly or wirelessly connected to said means for atomizing said substrates and configured to atomize said substrates using a pre-determined intensity and duration of atomization over time to generate an aerosol mixture corresponding to at least one flavor profile;
providing means for activating said programmable controller to generate said aerosol mixture within said chamber which can be inhaled by a user from the outlet.
